(19) United States
(12) Patent Application Publication
(10) Pub. No.: US 2007/0154770 A1
(43) Pub. Date: Jul. 5, 2007

(54) End plate for an electrochemical cell stack

(76) Inventors: David Frank, Scarborough (CA); Nathaniel Ian Joos, Toronto (CA); Ricardo Bazzarell, Cambridge (CA); Dzamarija Mario, Toronto (CA)

Correspondence Address: BERESKIN AND PARR, 40 KING STREET WEST, BOX 401, TORONTO, ON, M5H 3Y2, CA

(21) Appl. No.: 10/568,343

(22) PCT Filed: Aug. 16, 2004
(86) PCT No.: PCT/CA04/01513

§ 371 Date: Dec. 1, 2006

Related U.S. Application Data
(60) Provisional application No. 60/495,089, filed on Aug. 15, 2003.

(51) Int. Cl. H01M 8/02; B31B 45/00

(52) U.S. Cl. 429/38; 428/34.1

(57) ABSTRACT

An end plate for an electrochemical cell stack is described herein. The end plate includes an outer face and an inner face, wherein a plurality of cavities are provided on the inner face. The inner face comprises a central region and a peripheral region surrounding the central region and a first plurality of cavities are provided in the central region forming an array of cavities. The end plate further comprises a second plurality of cavities in the peripheral region.

### FIELD OF INVENTION

The present invention relates to end plates for an electrochemical cell stack.

### BACKGROUND OF THE INVENTION

Electrochemical cell stacks include fuel cell stacks and electrolyzers. A fuel cell is an electrochemical device that produces an electromotive force by bringing a fuel (typically hydrogen gas) and an oxidant (typically air or oxygen gas) into contact with two suitable electrodes and an electrolyte. The fuel is introduced at a first electrode where it reacts electrochemically in the presence of the electrolyte to produce electrons and cations. The electrons are circulated from the first electrode to a second electrode via an electrical circuit. Cations pass through the electrolyte to the second electrode.

Simultaneously, the oxidant is introduced to the second electrode where the oxidant reacts electrochemically in presence of the electrolyte and catalyst, producing anions and consuming the electrons circulated through the electrical circuit; the cations are consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode.

The half-cell reactions at the two electrodes are, respectively, as follows:
H₂→2H++2e
½O₂+2H++2e−→H₂O
The external electrical circuit withdraws electrical current and thus receives electrical power from the fuel cell. The overall fuel cell reaction produces electrical energy as shown by the sum of the separate half-cell reactions written above. Water and heat are typical by-products of the reaction.

Conceptually, electrolyzers are fuel cells run in reverse, and share many of the same components as fuel stacks. In particular, a current is supplied to the electrolyzer for the electrolysis of water into hydrogen and oxygen gases. In a fuel cell, hydrogen and oxygen are combined to produce water and release heat. In an electrolyzer, energy is required to break up water into hydrogen and oxygen.

In practice, fuel cells are not operated as single units. Rather, fuel cells are connected in series, stacked one on top of the other, or placed side by side, to form what is usually referred to as a fuel cell stack. As used herein, the term “cell stack” includes the special case where just one fuel cell is present, although typically a plurality of fuel cells are stacked together to form a cell stack. The fuel and oxidant are directed through manifolds to the electrodes, while cooling is provided either by the reactants or by a cooling medium. Also within the stack are current collectors, cell-to-cell seals and insulation, with required piping and instrumentation provided externally of the fuel cell stack.

A fuel cell stack includes two end plates that sandwich components of the fuel cell stack. End plates provide integrity to the fuel cell stack by acting as an anchor for rods or bolts that are used to compress together various components of the cell stack resting between the end plates. Moreover, end plates can contain connection ports to which are attached fuel, oxidant and coolant ducts or hoses. These process fluids flow through the connection ports into and out of the fuel cells stack.

End plates must be strong enough to bear the forces required to compress components of the fuel cell stack and to secure fuel, oxidant and coolant ducts or hoses to the respective ports of the end plate. For this reason, end plates are thicker and are composed of a heavier material than most of the other components of the fuel cell stack. Thus, conventional end plates are made of metal and are thick and heavy to be sufficiently strong for their intended use.

Because fuel cell stacks typically contain many fuel cells stacked on top of one another, even without end plates the weight and size of a fuel cell stack is not insignificant. When the weight of end plates is factored in, a fuel cell stack containing several hundred plates can have considerable weight. Any innovation that could help reduce the size and weight of a fuel cell stack would increase the performance and range of application of such stacks, and would therefore be most welcome in the field of electrochemical cell stacks.

### SUMMARY OF THE INVENTION

Described herein is an end plate for an electrochemical cell stack. The end plate includes an inner face, an outer face, two end faces, a top face and a bottom face. The end plate has at least one cavity for reducing the weight of the end plate, the at least one cavity on at least one of the inner face, the two end faces, the top face and the bottom face. For example, the at least one cavity can comprise at least fifteen percent of the volume of the end plate. The at least one cavity can be a blind hole with a depth of at least 40% or 60% of the thickness of the end plate. Each of the at least one cavity can have a width of at least one-sixth the size of the lateral length of the end plate. The presence of such cavities significantly reduces the weight of the end plate, which is advantageous when the end plates are used to form lighter electrochemical stacks.

Also described herein is an end assembly for an electrochemical cell stack. The end assembly includes at least two of a) an end plate for attaching at least one connection port thereto for transmitting a fluid, b) a terminal plate for connecting electrical leads thereto to draw current, and c) an insulator plate for insulating, wherein the at least two are secured together with a securing agent.

In addition, an end plate for an electrochemical cell stack is described herein that tapers in one or more directions to thereby reduce the weight of the end plate. In particular, the end plate includes an inner face and an outer face each having a central region and a peripheral region, a thickness measured along a stacking direction perpendicular to the central regions, a left end face and a right end face, and a height measured along a lateral direction that is perpendicular to the stacking direction and parallel to the left and right end faces. The end plate tapers to reduce weight such that at least one of the following two conditions holds: i) the thickness of the end plate is smaller near the peripheral regions proximate to the end faces than near the central regions, and ii) the height of the end plate is smaller near the peripheral regions proximate to the end faces than near the central regions.

An end plate for an electrochemical cell stack is also described herein having an inner face, an end face substantially perpendicular to the inner face, an end face opening on the end face, and an inner face opening on the inner face. The end face opening and the inner face opening are in fluid communication for the flow of fuel, oxidant or coolant.

Also described herein is an end plate having an outer face, an outer connection port on the outer face for allowing a fluid to pass therethrough, an inner face, and an inner connection port on the inner face that corresponds to the outer connection port. The outer connection port has a counter bore with an enlarged diameter and an inner bore with a reduced diameter for securing an external line for the fluid, the inner bore being in fluid communication with the inner connection port.

### BRIEF DESCRIPTION OF DRAWINGS

For a better understanding of the present invention, and to show more clearly how it may be carried into effect, reference will now be made, by way of example, to the accompanying drawings, which show preferred embodiments of the present invention and in which:

FIG. 1 illustrates an exploded perspective view of a fuel cell unit located within a fuel cell stack;

FIG. 2 illustrates a first perspective view of a first embodiment of an end plate in accordance with the present invention;

FIG. 3 illustrates a second perspective view of the first embodiment of the end plate in accordance with the present invention;

FIG. 4 illustrates a front elevational view of the first embodiment of the end plate in accordance with the present invention;

FIG. 5 illustrates a side elevational view of the first embodiment of the end plate in accordance with the present invention;

FIG. 6 illustrates a top view of the first embodiment of the end plate in accordance with the present invention;

FIG. 7 illustrates a back elevational view of the first embodiment of the end plate in accordance with the present invention;

FIG. 8 illustrates a sectional view of the first embodiment of the end plate in accordance with the present invention, along line E-E of FIG. 7;

FIG. 9 illustrate a sectional view of the first embodiment of the end plate in accordance with the present invention, along line A-A of FIG. 4;

FIG. 10 illustrates a sectional view of the first embodiment of the end plate in accordance with the present invention, along line B-B of FIG. 7;

FIG. 11 illustrates a first perspective view of a second embodiment of the end plate in accordance with the present invention;

FIG. 12 illustrates a second perspective view of the second embodiment of the end plate in accordance with the present invention;

FIG. 13 illustrates a front elevational view of the second embodiment of the end plate in accordance with the present invention;

FIG. 14 illustrates a back elevational view of the second embodiment of the end plate in accordance with the present invention;

FIG. 15 illustrates a side elevational view of the second embodiment of the end plate in accordance with the present invention;

FIG. 16 illustrates a top view of the second embodiment of the end plate in accordance with the present invention;

FIG. 17 illustrates a sectional view of the second embodiment of the end plate in accordance with the present invention, along line C-C of FIG. 14;

FIG. 18 illustrates a sectional view of the second embodiment of the end plate in accordance with the present invention, along line D-D of FIG. 14;

FIG. 19 illustrates a first perspective view of a third embodiment of the end plate in accordance with the present invention;

FIG. 20 illustrates a second perspective view of a third embodiment of the end plate in accordance with the present invention;

FIG. 21 illustrates a front elevational view of the third embodiment of the end plate in accordance with the present invention;

FIG. 22 illustrates a back elevational view of the third embodiment of the end plate in accordance with the present invention;

FIG. 23 illustrates a side elevational view of the third embodiment of the end plate in accordance with the present invention;

FIG. 24 illustrates a top view of the third embodiment of the end plate in accordance with the present invention;

FIG. 25 illustrates a sectional view of the third embodiment of the end plate in accordance with the present invention, along line F-F of FIG. 21;

FIG. 26 illustrates a sectional view of the third embodiment of the end plate in accordance with the present invention, along line G-G of FIG. 22;

FIG. 27 illustrates a sectional view of the third embodiment of the end plate in accordance with the present invention, along line H-H of FIG. 22;

FIG. 28 illustrates a first perspective view of a fourth embodiment of the end plate in accordance with the present invention;

FIG. 29 illustrates a second perspective view of the fourth embodiment of the end plate in accordance with the present invention;

FIG. 30 illustrates a front elevational view of the fourth embodiment of the end plate in accordance with the present invention;

FIG. 31 illustrates a back elevational view of the fourth embodiment of the end plate in accordance with the present invention;

FIG. 32 illustrates a side elevational view of the fourth embodiment of the end plate in accordance with the present invention;

FIG. 33 illustrates a top view of the fourth embodiment of the end plate in accordance with the present invention;

FIG. 34 illustrates a sectional view of the fourth embodiment of the end plate in accordance with the present invention, along line I-I of FIG. 31;

FIG. 35 illustrates a sectional view of the fourth embodiment of the end plate in accordance with the present invention, along line J-J of FIG. 31;

FIG. 36 shows the inner face of an end plate in accordance with the present invention;

FIG. 37 shows the outer face of an end plate in accordance with the present invention;

FIG. 38 shows an assembly of an end plate, an insulator plate and a terminal plate in accordance with the present invention;

FIGS. 39A and 39B show the insulator plate of FIG. 38; and

FIG. 40 shows the terminal plate of FIG. 38.

### DETAILED DESCRIPTION OF PREFERRED EMBODIMENTS

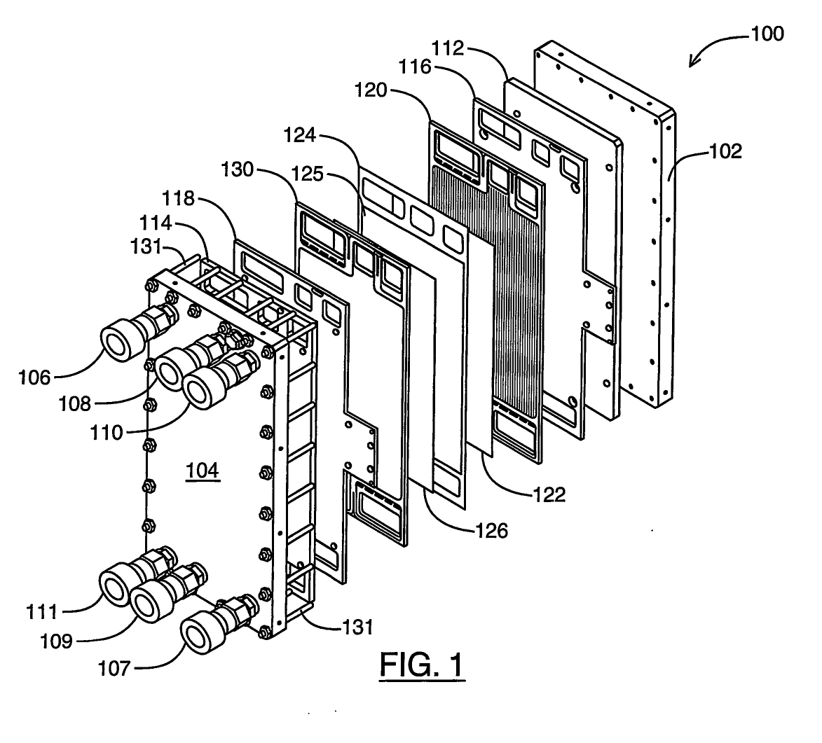

FIG. 1 shows an exploded perspective view of a conventional fuel cell unit 100. The fuel cell unit 100 includes an anode flow field plate 120, a cathode flow field plate 130 that sandwich a membrane electrode assembly (MEA). Various sizes are possible for the plated 120 and 130. In one embodiment, the short edge of the flow field plates 120, 130 is about 12 cm. Each plate 120 and 130 has an inlet region, an outlet region, and open-faced channels (not shown). The channels fluidly connect the inlet region to the outlet region, and provide a way for distributing the reactant gases to the outer surfaces of the MEA 124.

The MEA 124 comprises a solid electrolyte (i.e. a proton exchange membrane or PEM) 125 disposed between an anode catalyst layer (not shown) and a cathode catalyst layer (not shown). A first gas diffusion layer (GDL) 122 is disposed between the anode catalyst layer and the anode flow field plate 120, and a second GDL 126 is disposed between the cathode catalyst layer and the cathode flow field plate 130. The GDLs 122, 126 facilitate the diffusion of the reactant gas, either the fuel or oxidant, to the catalyst surfaces of the MEA 124. Furthermore, the GDLs enhance the electrical conductivity between each of the anode and cathode flow field plates 120, 130 and the membrane 125.

A first current collector plate 116 abuts against the rear face of the anode flow field plate 120, where the term “rear” indicates the side facing away from the MEA 124. Likewise, the term “front” refers to the side facing the MEA. A second current collector plate 118 abuts against the rear face of the cathode flow field plate 130. Each of the first and second current collector plates 116 and 118 respectively has a tab 146 and 148 protruding from the side of the fuel cell stack. A first insulator plate and second insulator plates 112, 114 are located immediately adjacent the first and second current collector plates 116, 118, respectively. First and second end plates 102, 104 are located immediately adjacent the first and second insulator plates 112, 114, respectively. Pressure may be applied on the end plates 102, 104 to press the unit 100 together. Moreover, sealing means are usually provided between each pair of adjacent plates. Preferably, a plurality of tie rods 131 may also be provided. The tie rods 131 are screwed into threaded bores in the anode endplate 102, and pass through corresponding plain bores in the cathode endplate 104. Fastening means, such as nuts, bolts, washers and the like are provided for clamping together the fuel cell unit 100.

The endplate 104 is provided with a plurality of connection ports for the supply of various fluids. Specifically, the second endplate 104 has first and a second air connection ports 106, 107, first and second coolant connection ports 108, 109, and first and second hydrogen connection ports 110, 111. The MEA 124, the anode and cathode flow field plates 120, 130, the first and second current collector plates 116, 118, the first and second insulator plates 112, 114, and the first and/or second end plates 102, 104 have three inlets near one end and three outlets near the opposite end, which are in alignment to form fluid ducts for air as an oxidant, a coolant, and hydrogen as a fuel. Also, it is not essential that all the outlets be located at one end, i.e., pairs of flows could be counter current as opposed to flowing in the same direction. The inlet and outlet regions of each plate are also referred to as manifold areas. Although not shown, it will be understood that the various ports 106-111 are fluidly connected to ducts that extend along the length of the fuel cell unit 100.

In the fuel cell stack shown in FIG. 1, the fuel cell stack runs in “closed-end” mode, which means process fluids and coolant are supplied to and discharged from same end of the fuel cell stack. It should be understood that in other versions, the fuel cell may run in “flow-through” mode where process fluids and coolant enter the fuel cell stack from one end and leave the stack from the opposite end thereof. This requires the first end plate 102 be provided with corresponding connection ports for process fluids. It should also be understood that in practice it is useful to stack the several plates 130, 120 and MEAs 124 to form a fuel cell stack to produce a greater current output. Cell stacks may have more than one hundred MEAs 124.

Although it is often beneficial to stack many cells in a stack to increase the voltage output, there is a price to be paid in the overall size and weight of the cell stack when stacking many cells. Aggravating the shortcomings that arise from copious stacking is the fact that end plates are thicker and are composed of a heavier material than most of the other components of the fuel cell stack to be strong enough to bear the forces required to compress components of the fuel cell stack and to secure fuel, oxidant and coolant ducts or hoses to the respective ports of the end plate. Thus, conventional end plates are made of metal and are thick and heavy to be sufficiently strong for their intended use. To address these shortcomings, a new design for an end plate that significantly reduces the overall weight of the cell stack is now described.

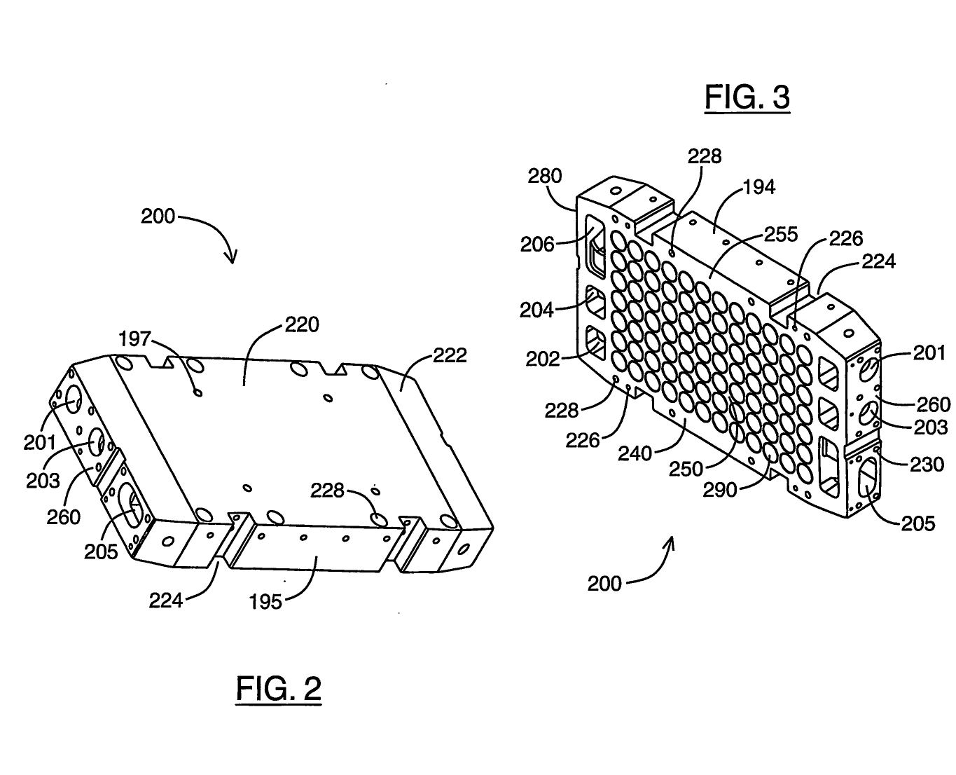

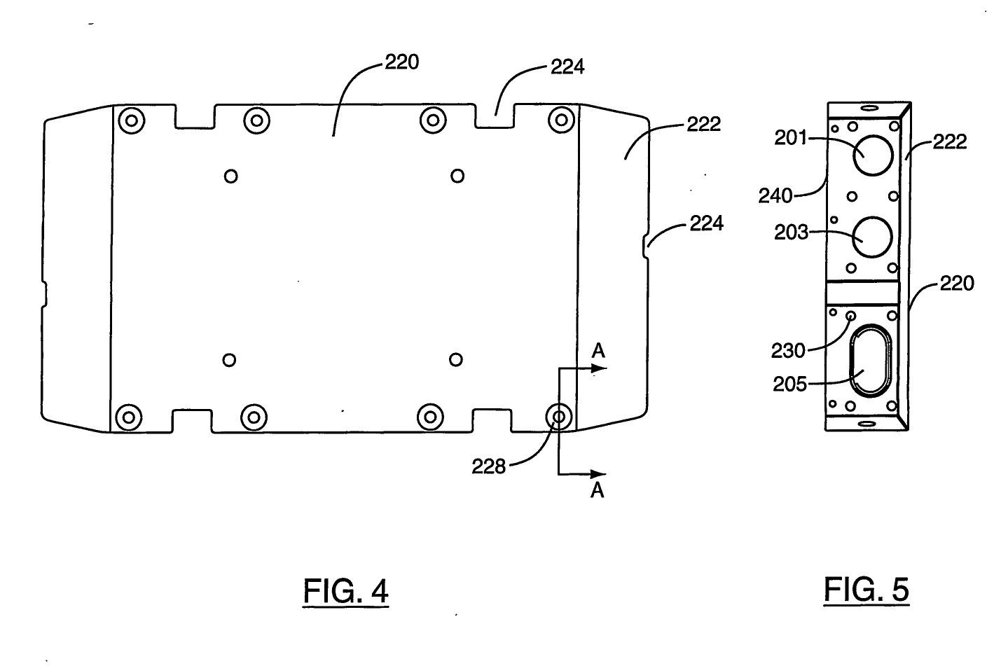

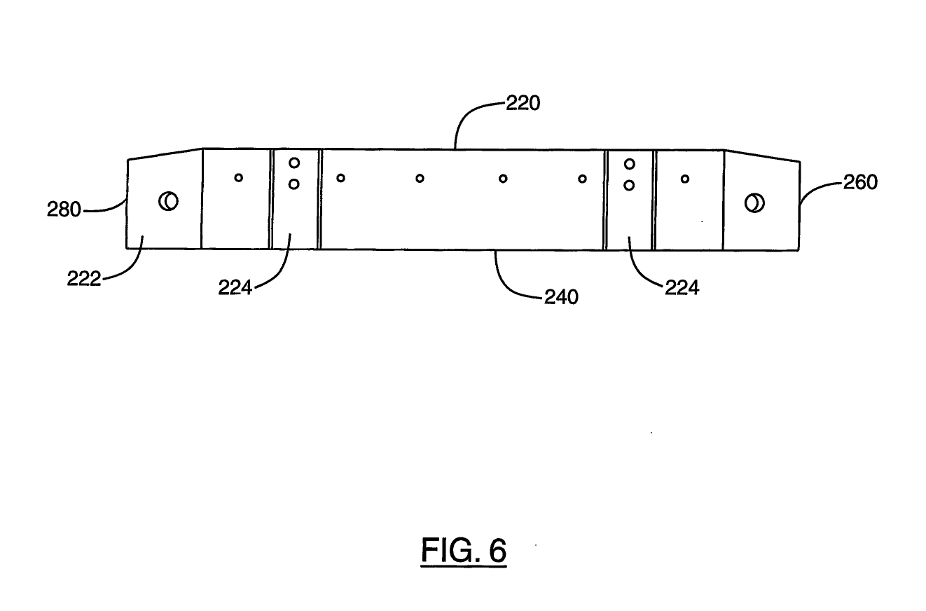

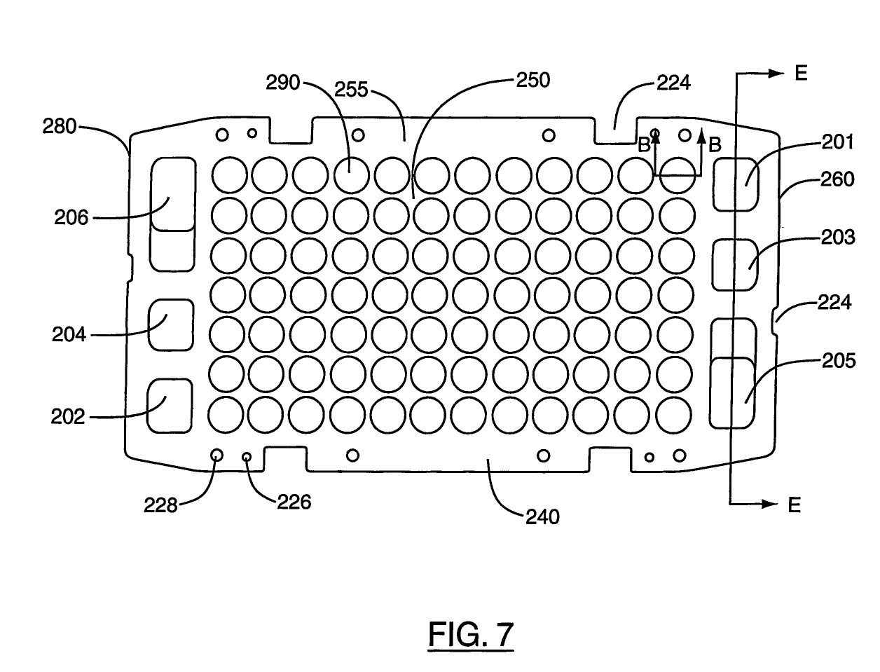

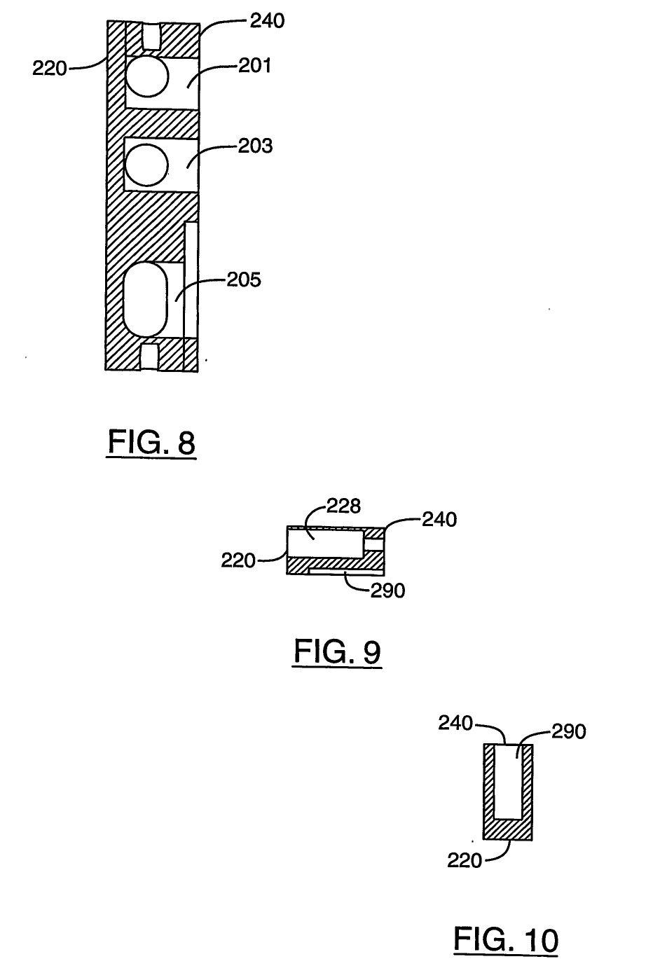

FIGS. 2-10 show a first embodiment of an end plate 200 according to the present invention. The end plate 200 has an outer face 220 and an inner face 240, where “outer face” and “inner face” with respect to end plates indicate the side facing away from the fuel cells located within the stack and the side facing towards the fuel cells located within the stack, respectively. The end plates 200 have two opposite end faces 260 and 280. The end plates 200 also have a top face 194 opposite a bottom face 195. Three connection ports 201, 203 and 205 are provided on the end face 260 and another three connection ports 202, 204 and 206 are provided on the opposite end face 280. It is to be understood that the end plate 200 could be square-shaped instead of rectangular-shaped and the connection ports may be provided on the two opposite end faces.

The inner face 240 of the end plate 200 has a central region 250 and a peripheral region 255 surrounding the central region 250. The connection ports 201-206 extend from their associated end faces 260, 280 along the longitudinal direction of the end plate 200 (i.e., the direction perpendicular to the end faces 260, 280) toward the inside thereof to a certain extent and then extend in a direction substantially perpendicular to the inner face 240 and the outer face 220, toward the inner face 240 and form openings thereon. In other words, each of the connection ports 201-206 is L-shaped so that the port 201, for example, has an opening on the end face 260 and an opening on the inner face 240, the openings being in fluid communication; the opening on the end face 260, the opening on the inner face 240, and the port as a whole are all denoted by the same reference number.

The openings 201-206 are located in the peripheral region 255. A plurality of cavities 290 are provided in the central region 250. The plurality of cavities 290 are preferably disposed such that they align in both longitudinal and lateral directions (the lateral direction being perpendicular to the longitudinal direction previously defined and parallel to the outer and inner faces 220, 240), and hence an array of m rows and n columns of cavities is formed in the central region 250.

As used herein, the term “cavity” refers to any hollow, or hole, either a through hole or a blind hole of any shape. The particular cavities 290 shown in the embodiment of FIGS. 2-10 are round, blind holes provided on the inner face 240, and preferably have substantially the same dimension. They extend along the thickness direction of the end plate 200 to a certain extent. The depth of the cavities 290 is in the range of 40%-80% of the thickness of the end plate 200 and preferably in the range of 60%-80%. The presence of the cavities 290 reduces the material and hence weight of the end plate 200. In other embodiments, the cavities can be provided on the outer face 220 instead of the inner face 240. Alternatively, cavities can be provided on both faces 220 and 240. More generally, cavities can be provided anywhere on or in the end plate 200, including any of its faces, such as the outer face 220 and inner face 240 already mentioned, the end faces 240, 260, and the top and bottom faces 194, 195. Aside from perhaps being air-filled, the cavities are otherwise empty during operation of the cell stack. The cavities can each be of various sizes and shapes. Besides circles, other shapes that “tile” the face better, such as triangles, may be employed to reduce the weight further.

When the cavities are on the inner face 240, they can increase the stiffness of the assembly of terminal, insulator and end plates by forming a laminate-like structure.

When a fuel cell stack is assembled, the entire inner face 240 engages with an insulator plate as described below in more detail. Therefore, with pressure applied from ends of the stack and the cavities being provided on the inner face 240 or outer face 220, or as through holes linking the two faces 220, 240, the end plate 200 maintains its robustness in spite of the cavities. The insulator plate is sandwiched between the end plate 200 and a terminal plate (also known as a current collector plate or bus bar). All three plates are joined together with bolts, or other securing agents, as will be described below. The bolted assembly is much stronger than in a conventional stack where the three plates are simply juxtaposed or stacked together. The present assembly, with its laminar structure, is much stiffer than three loose pieces, but remains lightweight. It is also possible to bond all three plates together using conventional bonding methods to ensure that the components are held together during assembly, that no electrical shorting occurs through the components, and to create an even stiffer stack. Optional external mounting points 197 are also provided on the outer face 220.

The peripheral region 255 of the end plate 200 is provided with a plurality of through holes 228. The through holes 228 can also be threaded holes or blind holes. The through holes are adapted to accommodate tie rods.

In this embodiment, four blind holes 226 are provided in the peripheral region 255 into which bolts can be inserted. Although not shown in this embodiment, it is easy to understand that the bolts pass through the corresponding through holes in the insulator plate and the current collector plate, bolting the three plates together.

On the end faces 260, 280, a plurality of threaded holes 230 are provided around each of the connection ports 201-206 for securing fluid ducts or hoses to the end faces through which process fluids can be supplied to and directed out of the fuel cell stack through the connection ports 201-206. On the side faces of the end plate 200, a plurality of positioning notches 224 are provided to facilitate the alignment of the end plate 200 and possibly fuel cell flow field plates (not shown) during assembly of the fuel cell stack.

The inner face 240 of the end plate 200 is substantially planar such that pressure can be uniformly passed on to insulator plate and hence the fuel cells within the stack. Each end of the end plate 200 has an inclined or tapered portion 222 on the outer face 220 where the thickness and height of the end plate 200 is gradually reduced, further reducing the dimension and hence weight of the end plate 200.

More specifically, to reduce weight, the thickness of the end plate in the stacking direction (i.e., the direction perpendicular to the longitudinal and lateral directions previously defined) is smaller near the peripheral regions proximate to the end faces than near the central regions, and the height in the lateral direction of the end plate is smaller near the peripheral regions proximate to the end faces than near the central regions.

The end plate 200 with the cavities 290 can be manufactured in a number of ways, such as machining, die casting, molding, conformal coating and overmolding with a polymer.

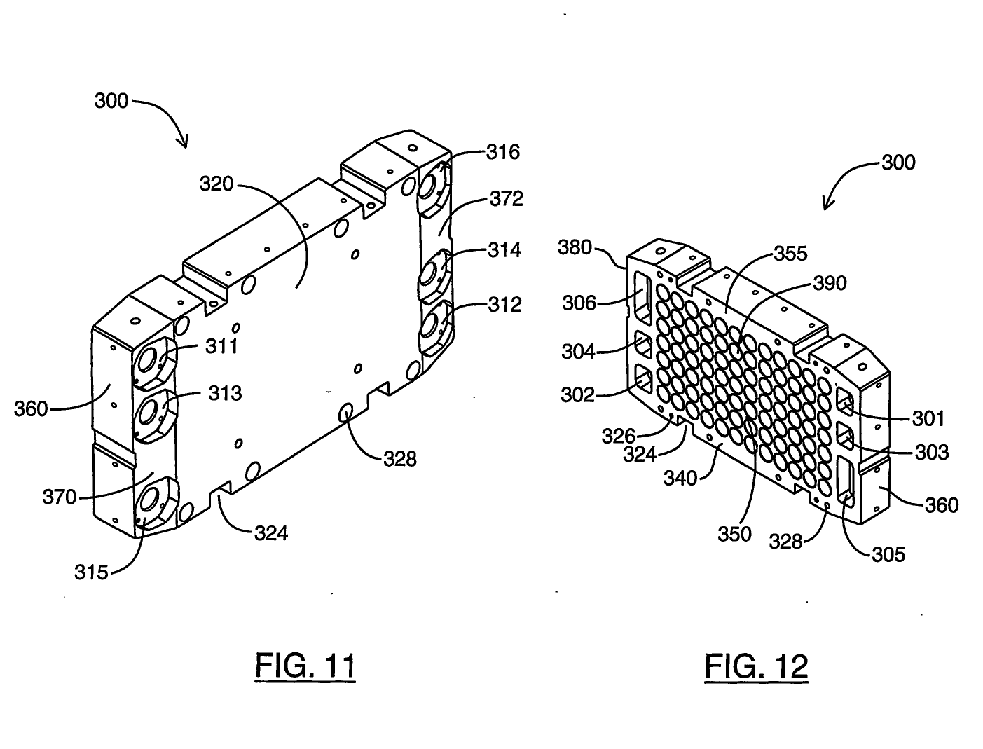

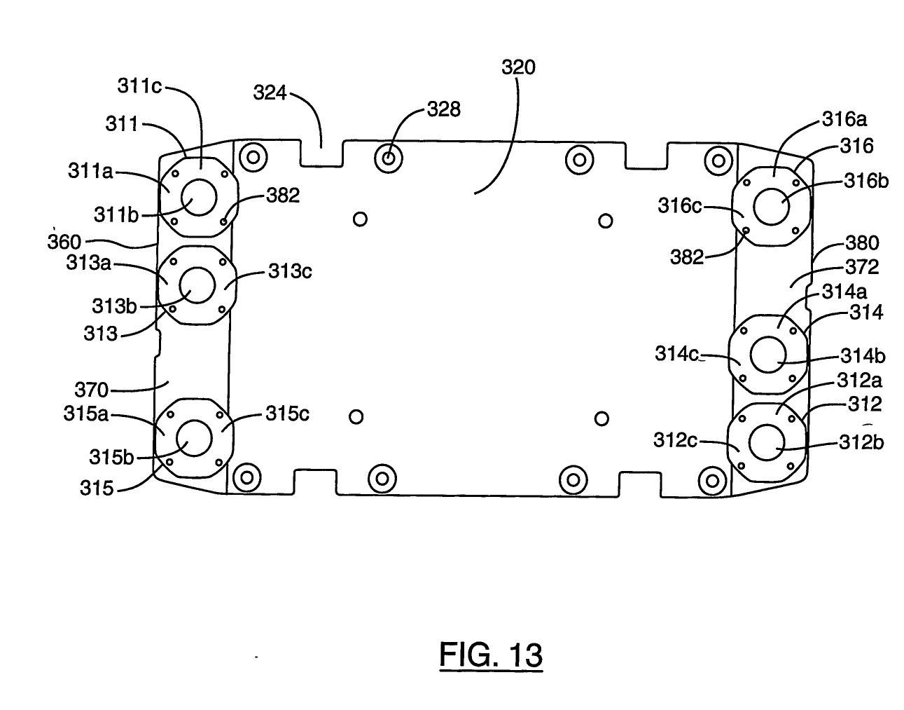

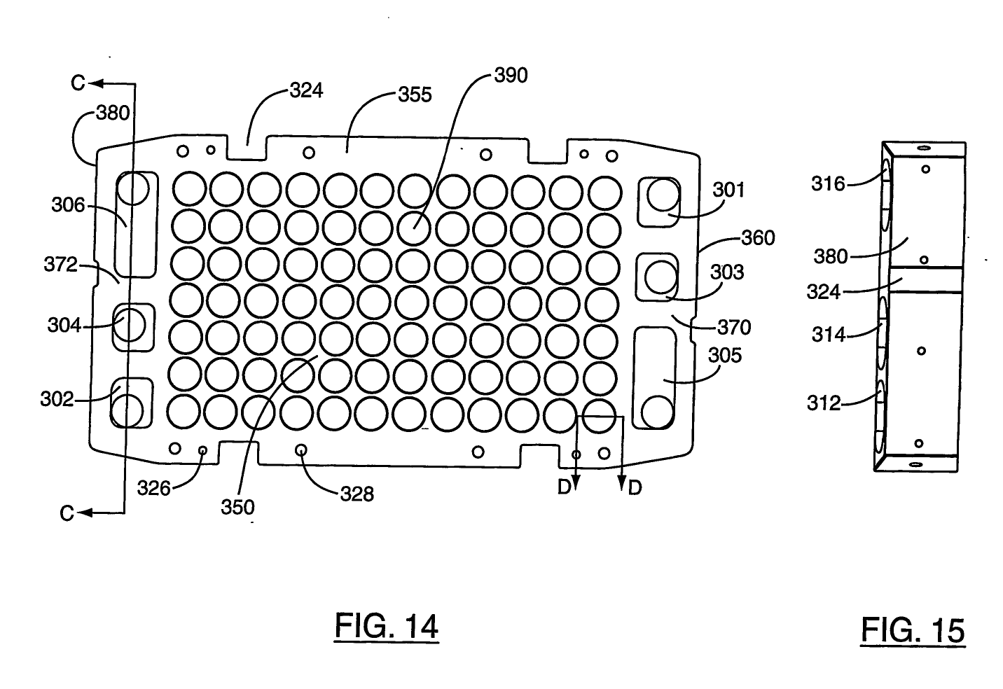

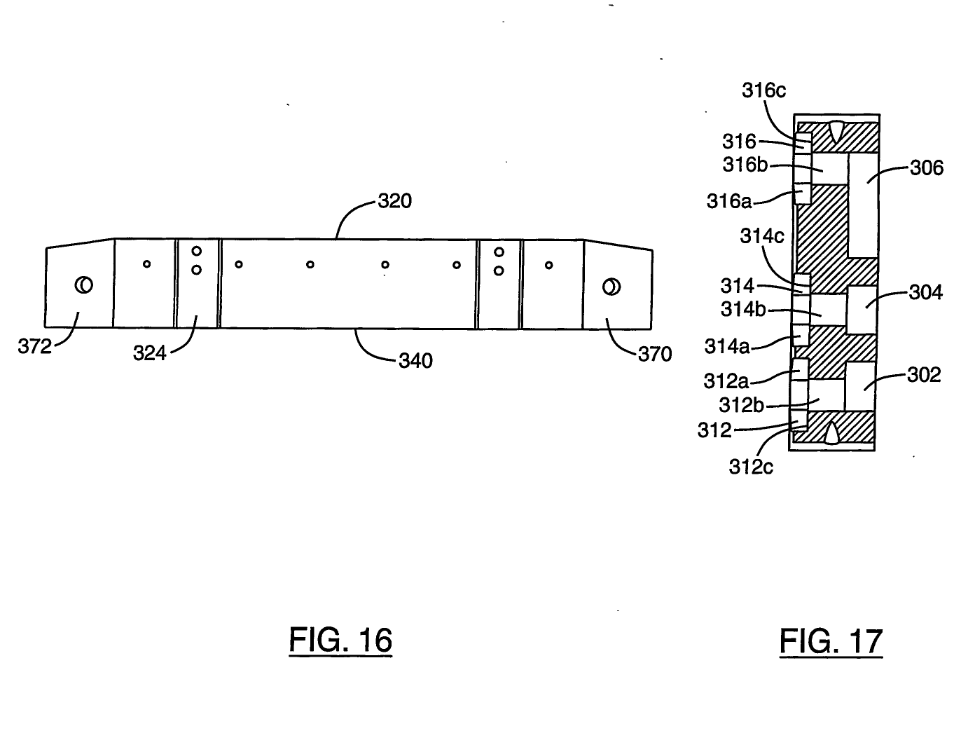

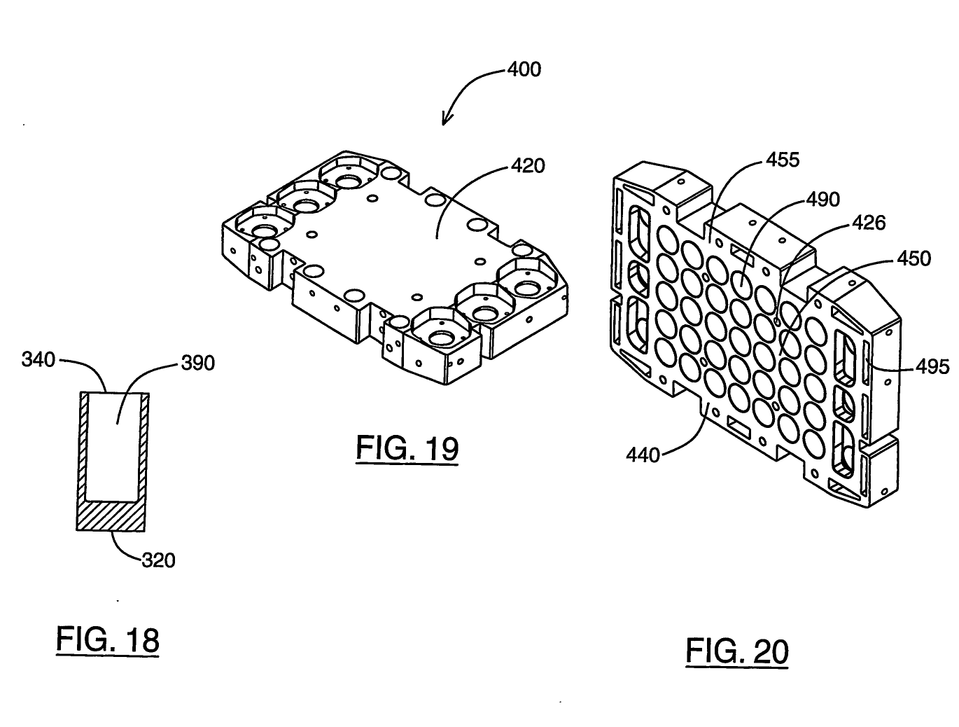

FIGS. 11-18 show a second embodiment of the end plate 300 according to the present invention. In the following embodiments, components performing similar functions to those in the first embodiment are indicated with the same last two digits, but with a different prefix. In the second embodiment, components are indicated with reference numbers beginning with “3.” In the second embodiment, the end plate 300 has an outer face 320 and an inner face 340. The end plates 300 have two opposite end faces 360 and 380. It is to be understood that the end plate 300 could be square-shaped instead of rectangular-shaped and the connection ports may be provided on the two opposite end faces 360, 380.

A first manifold region 370 is provided near the end face 360 and a second manifold region 372 near the opposite end face 380. On the inner face 340, three connection ports 301, 303 and 305 are provided in the first manifold region 370 and three connection ports 302, 304 and 308 are provided in the second manifold region 372. On the outer face 320, three connection ports 311, 313 and 315 are provided in the first manifold region 370 and three connection ports 312, 314 and 316 are provided in the second manifold region 372. The connection ports 301-306 fluidly communicate respectively with connection ports 311-316 to allow respective process fluids to flow from outer face 320 to inner face 340 and into the fuel cells within the fuel cell stack.

The connection ports 301-306 and 311-316 can take various shapes or forms, In this embodiment, on the inner face 340, the connection ports 301-306 are shaped such that they match the shape of inlet and outlet apertures of the adjacent plate within the fuel cell stack to minimize leakage of process fluids. On the outer face 320, each of the connection ports 311-316, for example, connection port 311, has a counter bore 311a with enlarged diameter and an inner bore 311b with reduced diameter. The inner bore 311b communicates with the corresponding connection port 301 provided on inner face 340 of the end plate 300. On the bottom face 311c of the counter bore 311a, a plurality of threaded holes 382 are provided. Threaded holes 382 are also provided on the bottom face of the counter bore of each connection port 312-316 for connection to external ducts or hoses.

The inner face 340 of the end plate 300 has a central region 350 and a peripheral region 355 surrounding the central region 350. A plurality of cavities 390 are provided in the central region 350. The plurality of cavities 390 are preferably disposed such that they align in both longitudinal and lateral directions, resulting in an array of cavities in the central region 350. Other arrangements are possible. In the embodiment of FIGS. 11-18, the cavities 390 are round, blind holes provided on the inner face 340, and preferably have substantially the same dimension. They extend along the thickness direction of the end plate 300 to a certain extent. The depth of the cavities 390 is in the range of 40%-80% of the thickness of the end plate 300 and preferably in the range of 60%-80%. The presence of the cavities 390 reduces the material and hence weight of the end plate 300 while maintaining its robustness.

The peripheral region 355 of the end plate 300 is provided with a plurality of through holes 328, which may be threaded. Instead of the through holes 328, blind holes may be provided. The through holes are adapted to accommodate tie rods. In this embodiment, four blind holes 326 are provided in the peripheral region 355 in which bolts can be inserted to secure the end plate, an insulator plate and a current collector plate (not shown) together in the same manner as described above. On the side faces of the end plate 300, a plurality of positioning notches 324 are provided to facilitate the alignment of the end plate 300 and possibly fuel cell flow field plates (not shown) during assembly of the fuel cell stack. The inner face 340 of the end plate 300 is flat such that pressure can be uniformly passed on to the insulator plate and hence to the fuel cells within the stack. The thickness and height of each manifold region 370 and 372 of the end plate 300 on the outer face 320 is gradually reduced. This further reduces the dimension and hence weight of the end plate 300.

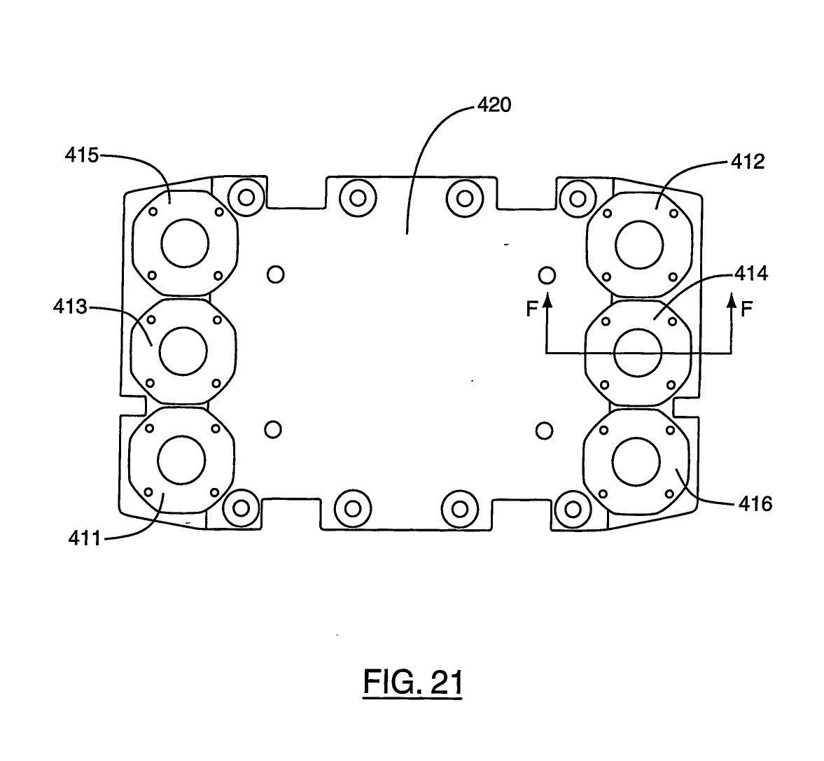

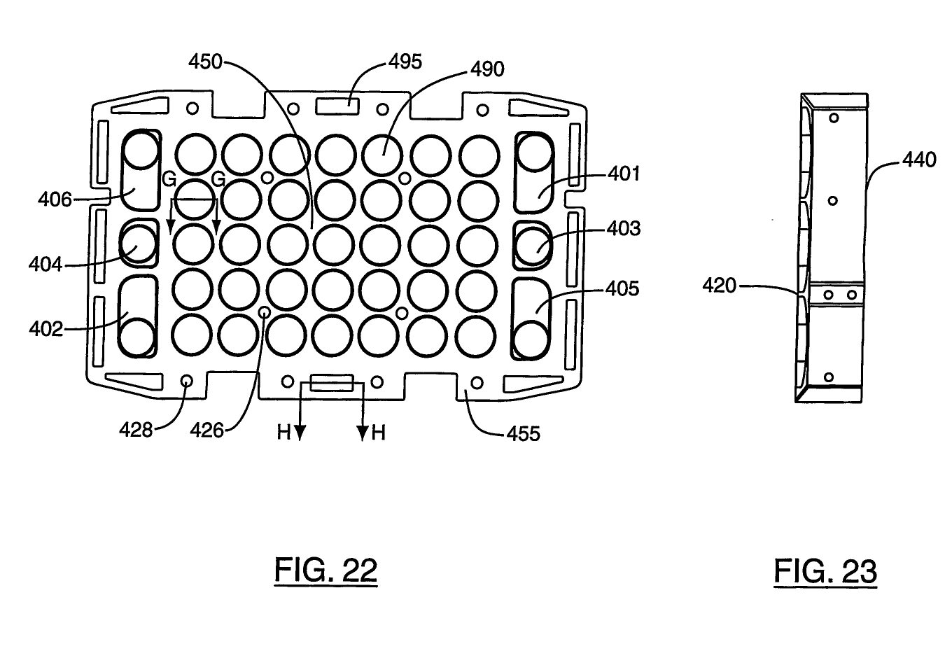

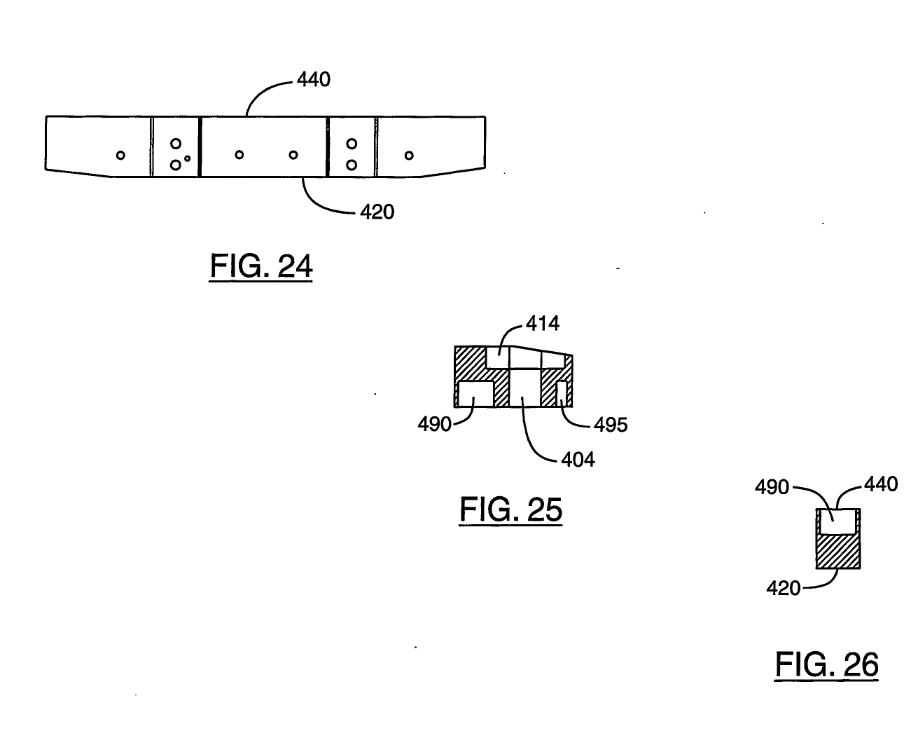

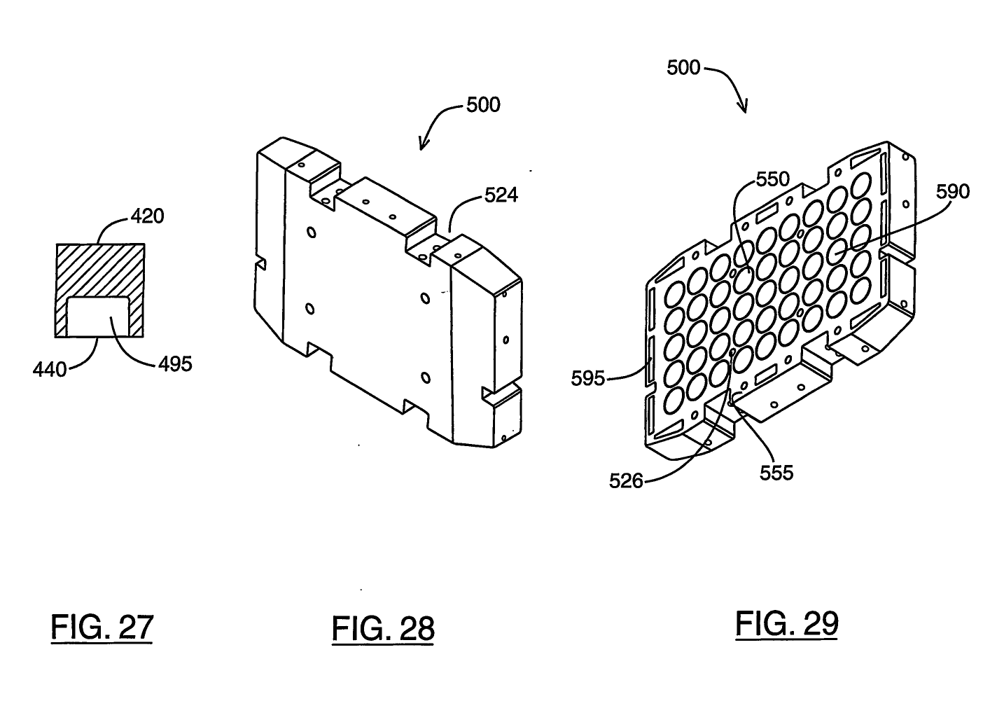

FIGS. 19-27 show a third embodiment of the end plate 400 in accordance with the present invention. The third embodiment of the end plate 400 is similar to the second embodiment and hence is not described in detail herein, and again components that are similar to those of earlier embodiments are identified using the same two last digits in the reference numerals. The inner face 440 of the third embodiment of the end plate 400 also has a central region 450 and a peripheral region 455 surrounding the central region 450. A plurality of central cavities 490 are provided in the central region 450. The plurality of central cavities 490 are preferably disposed such that they align in both longitudinal and lateral directions, and hence an array of cavities is formed in the central region 450. The central cavities 490 shown in FIGS. 19-27 are round, blind holes provided on the inner face 440, and preferably have substantially the same dimension. They extend along the thickness direction of the end plate 400 to a certain extent. The depth of the central cavities 490 is in the range of 40%-80% of the thickness of the end plate 400 and preferably in the range of 60%-80%. A depth of less than 40% and more than 80% may also be beneficial in some applications. For example, where the end plate 400 is made of a sufficiently strong material to permit the presence of holes deeper than 80%, than removing such an amount of material to lessen the weight can be advantageous.

The end plate 400 is further provided with a plurality of peripheral cavities 495 in the peripheral region 455. The dimensions of each peripheral cavity may not be the same. As can be seen in the figures, peripheral cavities 495 near each side face of the end plate 400 may be rectangular in shape while those near each corner may be substantially triangular. The peripheral cavities 495 are also blind holes provided on the inner face 440. The depth of the peripheral cavities 495 is in the range of 40%-80% of the thickness of the end plate 400 and preferably in the range of 60%-80%. The presence of the peripheral cavities 495 further reduces the material and hence weight of the end plate 400 while still maintaining its robustness. In this embodiment, four blind holes 426 are provided in the central region 450 on the inner face 440 of the end plate 400 for accommodating bolts that bolt the end plate, and insulator plate and a current collector plate (not shown) in the manner described below.

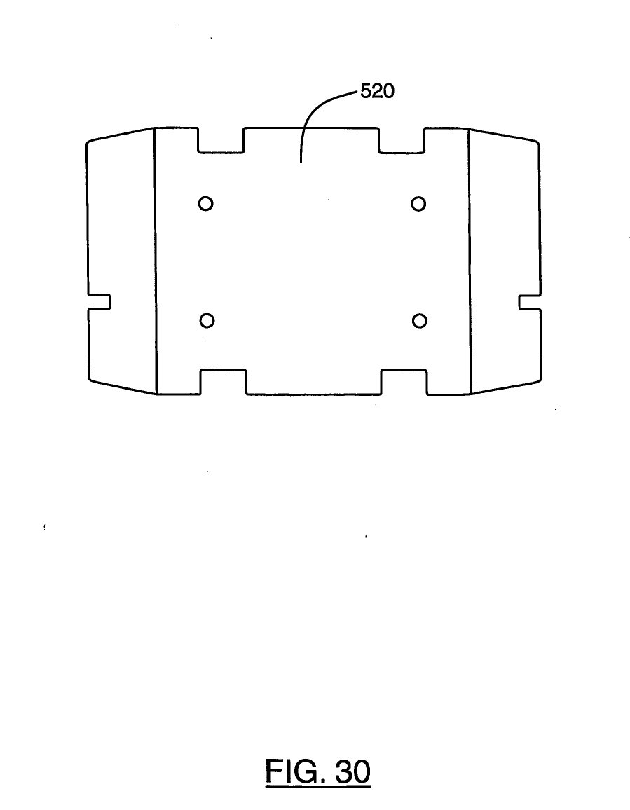

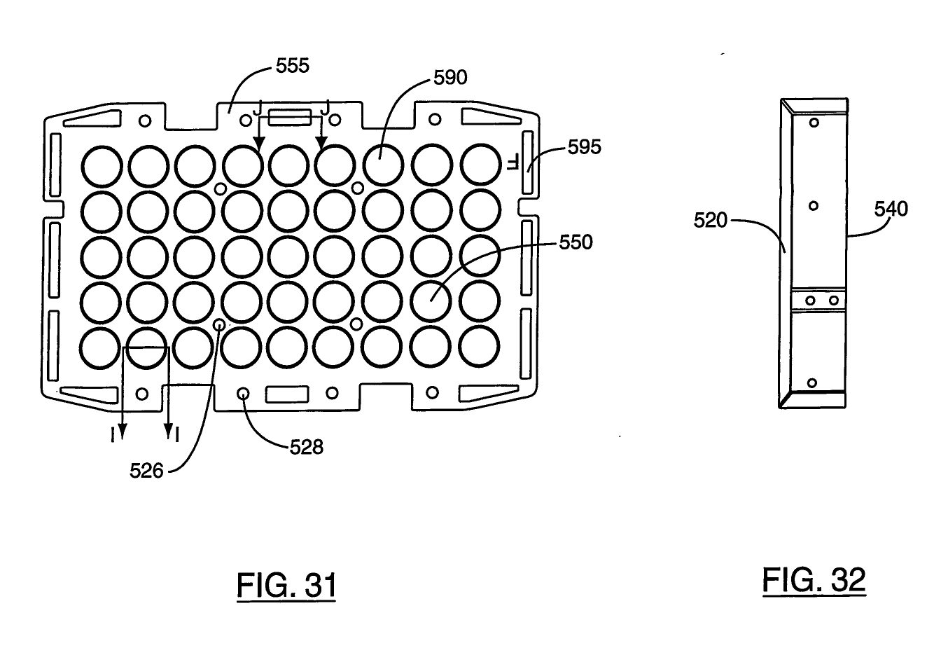

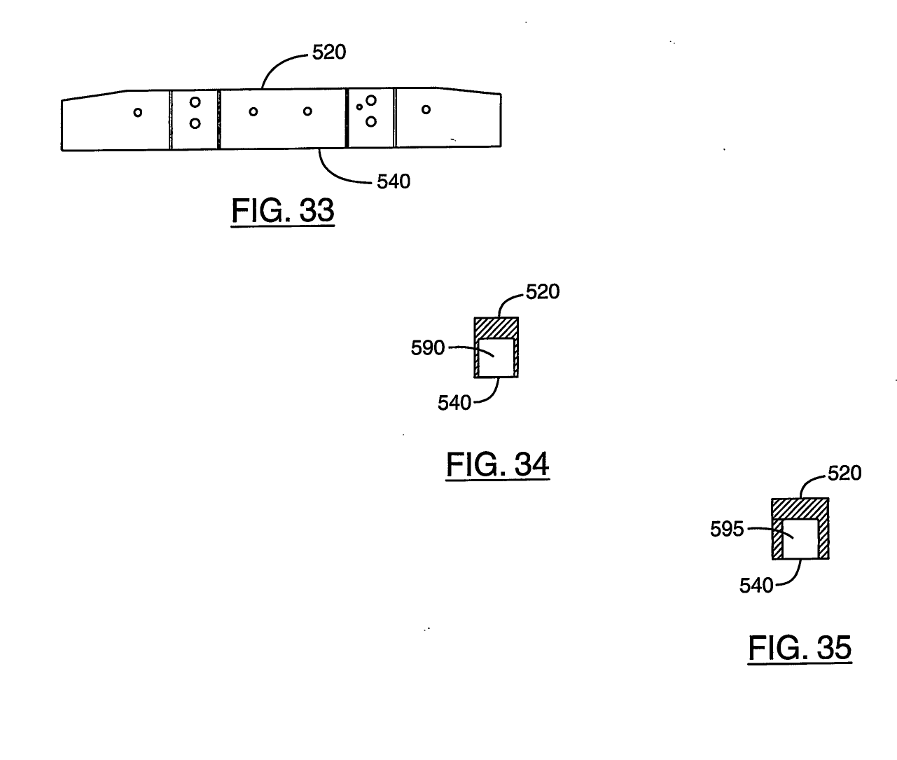

FIGS. 28-35 show a fourth embodiment of the end plate 500 in accordance with the present invention. The fourth embodiment of the end plate 500 is similar to the third embodiment of the end plate 400 and hence will not be described in detail. The end plate 500 also has, on its inner face 540, central cavities 590 in the central region 550 and peripheral cavities 595 in the peripheral region 555 surrounding the central region 550, as in the third embodiment. The difference from the third embodiment is that the end plate 500 is not provided with connection ports for connecting to process fluids. This end plate 500 can be used in the closed-end mode illustrated in FIG. 1.

In this embodiment, more areas are made available for either central cavities 590 or peripheral cavities 495 because of the absence of connection ports. This further reduces the weight of the end plate 500. The central cavities 590 and the peripheral cavities are all blind holes in the embodiment shown. The central cavities 590 may have a depth in the range of 40%-80% of the thickness of the end plate 400 and preferably in the range of 60%-80%. The peripheral cavities 595 may have a depth in the range of 40%-80% of the thickness of the end plate 400 and preferably in the range of 60%-80%. In this embodiment, four blind holes 526 are provided in the central region 550 on the inner face 540 of the end plate 500 for accommodating bolts that bolt the end plate, and insulator plate and a current collector plate (not shown) in the manner described below.

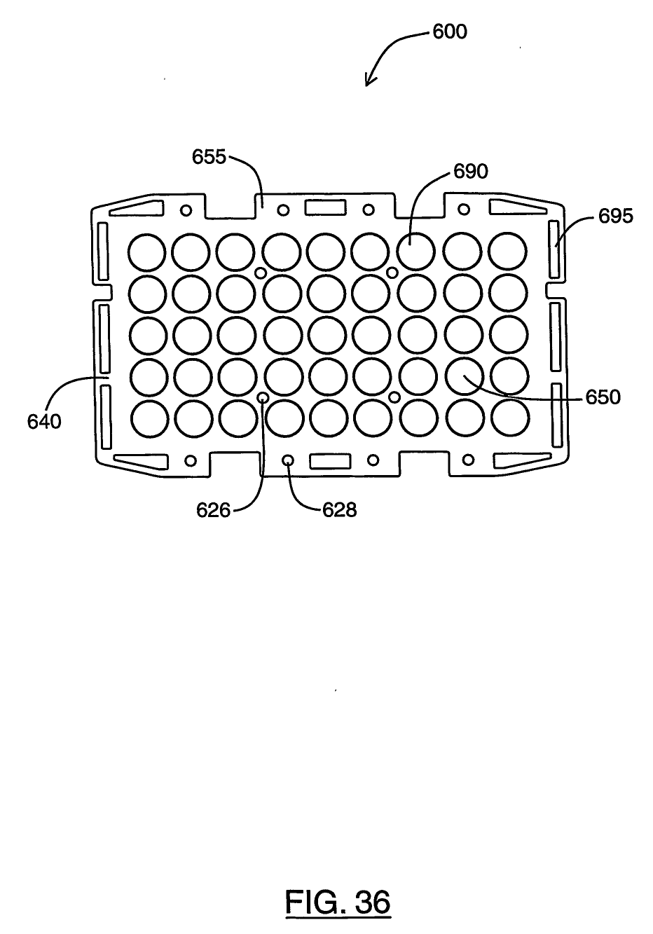

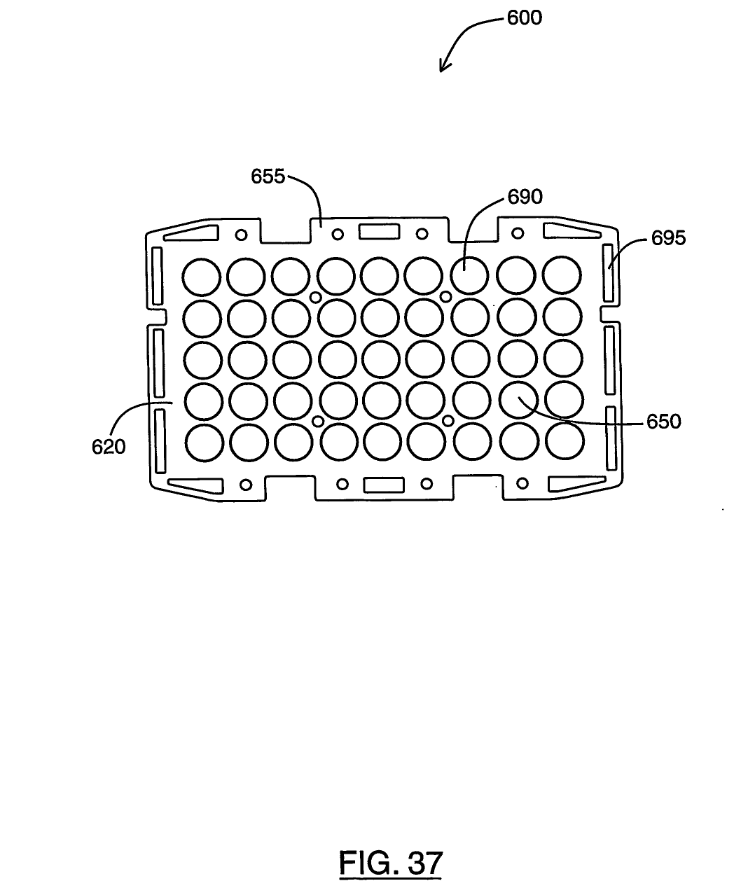

FIGS. 36 and 37 show yet another embodiment of the present invention in which the weight-reducing cavities on an end plate 600 are through holes instead of blind holes. The end plate 600 has an inner face 640 with a central region 650 and a peripheral region 655 surrounding the central region 650. A plurality of central cavities 690 are provided in the central region 650. The plurality of central cavities 690 are preferably disposed such that they align in both longitudinal and lateral directions, and hence an array of cavities is formed in the central region 650. The central cavities 690 shown in FIGS. 36 and 37 are cylindrical through holes from the inner face 640 to an outer face 620, and preferably have substantially the same size.

The end plate 600 is further provided with a plurality of peripheral cavities 695 in the peripheral region 655. The dimensions of each peripheral cavity may not be the same. The peripheral cavities 695 near each side face of the end plate 600 may be rectangular in shape while those near each corner may be substantially triangular. The peripheral cavities 695 are also through holes but in other embodiments the peripheral cavities 695 can be blind holes provided on the inner face 640.

The peripheral region 655 of the end plate 600 is provided with a plurality of through holes 628. The through holes 628 can also be threaded holes or blind holes. The through holes are adapted to accommodate tie rods for securing all of the components of cell stack, including the anode and cathode plates.

In this embodiment, four blind holes 626 are provided in the central region 650 on the inner face 640 of the end plate 600 for accommodating bolts that bolt together the end plate 600, an insulator plate (not shown) and a terminal plate (not shown) in the manner described below.

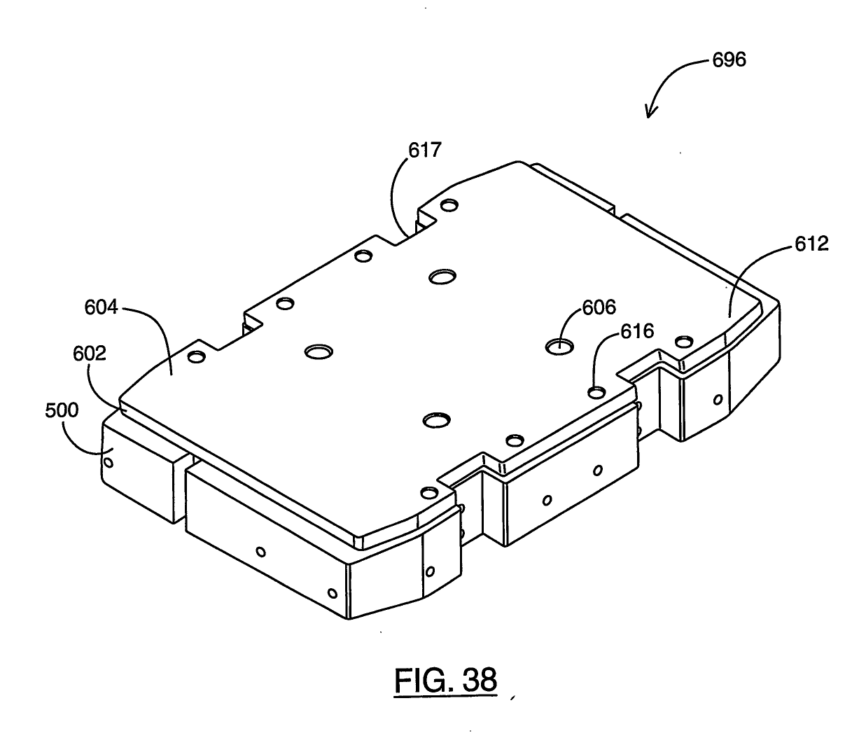

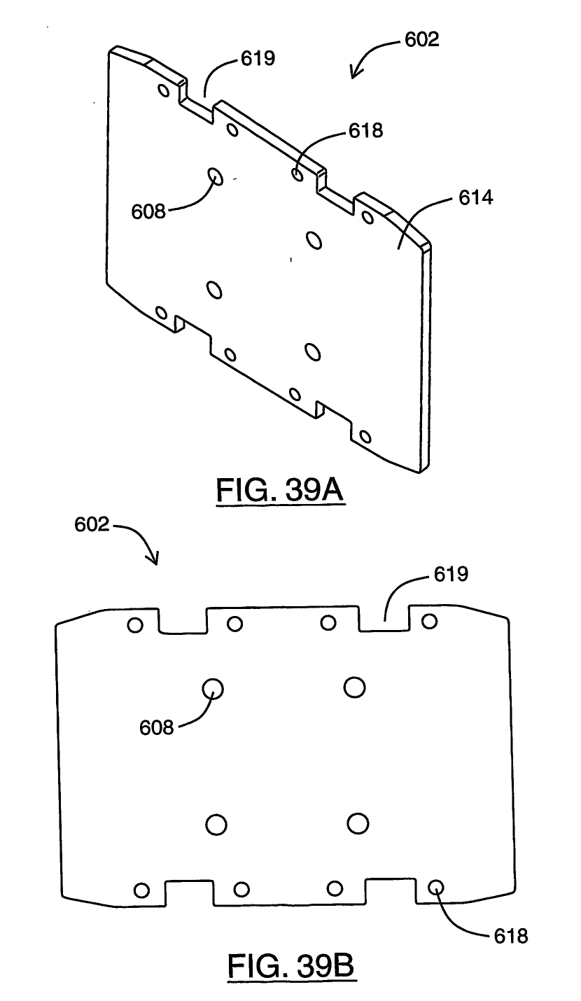

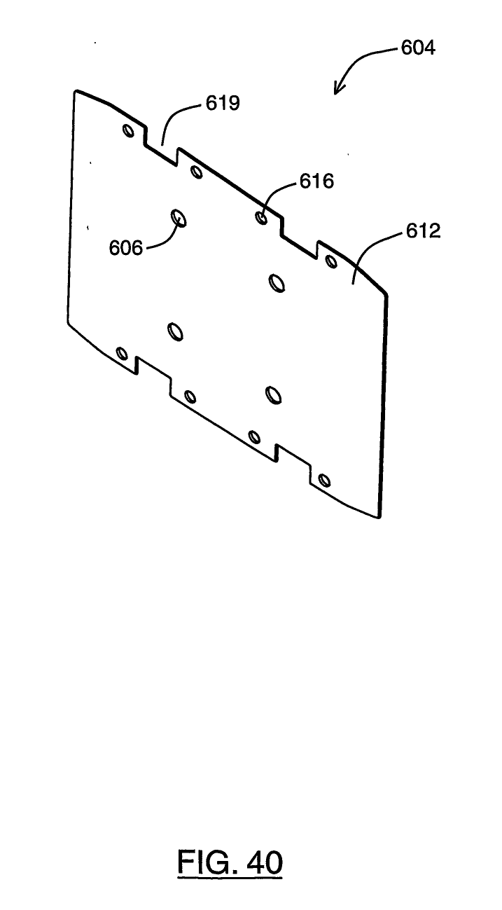

FIGS. 38, 39A, 39B and 40 show an end assembly 696 of the end plate 500, an insulator plate 602 and a terminal plate (current collector plate) 604, and individual components of the assembly. In the embodiment shown, the end assembly 696 may be used in a fuel cell stack running in a “closed-end” mode, which means process fluids and coolant are supplied to and discharged from same end of the fuel cell stack, but the basic design of the present invention also applies to the other end plate configurations. In this mode, the insulator plate 602 and the current collector plate 604 are not provided with inlets and outlets for fuel cell reactant. It should be understood that in other versions, the fuel cell may run in “flow-through” mode where process fluids and coolant enter the fuel cell stack from one end and leave the stack from the opposite end thereof. This requires the end plate be provided with corresponding connection ports for process fluids.

The peripheral regions 612 and 614 of the terminal plate 604 and the insulator plate 602 are provided with a plurality of through holes 616 and 618, which correspond to the through holes 528 of the end plate 500. The through holes 616 and 618 are adapted to accommodate tie rods for securing all of the components of cell stack, including the anode and cathode plates. The notches 617 and 619 correspond to the notches 524 on the end plate 500 and are provided to facilitate the alignment of the end plate 500, terminal 604, insulator plate 602 and fuel cell flow field plates (not shown) during assembly of the fuel cell stack.

Four holes 606 shown in the central region of the terminal plate 604 correspond to four holes 608 shown in the central region of the insulator plate 602 and also correspond to the blind holes 526. However, the number and position of holes 526, 606 and 608 can vary. The holes 606, 608 and 526 align in assembly. Nuts or threadings can be provided in the blind holes 526. Screws or bolts can be inserted through the holes 606 and 608 and screwed to the nuts or threadings in the blind holes 526 of the end plate 500.

The bolted assembly is stronger than conventional stacks in which the three plates are simply juxtaposed or stacked together The present assembly, with its laminar structure, is much stiffer than three loose pieces, but remains lightweight because of the presence of the cavities.

Instead of using screws or bolts, other securing agents may be used to secure the three plates into an end assembly 696. Possible securing agents include screws, snaps, glue, heat solder and weld.

In the embodiment of the end assembly 696 shown in FIG. 38, the end plate 500, the insulator plate 602, and the terminal plate 604 are all secured together. More generally, the end assembly includes at least two of a) an end plate, b) a terminal plate, and c) an insulator plate, wherein the at least two are secured together with a securing agent, in any order. For example, only the insulator plate 602 and the end plate 500 may be secured together.

The present invention is not limited to the embodiments shown or described above. For example, the end plate can be circular, oval and other shapes. Moreover, the shape of connection ports can vary. It is also to be understood that the present invention is also applicable to end plates of other electrochemical cells, such as electrolyzers. In addition, although reference was made to a PEM fuel cell stack of FIG. 1, the principles of the present invention can be applied to other fuel cell types. In addition to fuel cells, other electrochemical cell stacks, such as electrolyzers, can be manufactured according to the teachings of the present invention.

It is anticipated that those having ordinary skills in the art can make various modifications to the embodiments disclosed herein after learning the teaching of the present invention. For example, the number and arrangement of components in the system might be different, different elements might be used to achieve the same specific function. However, these modifications should be considered to fall under the protection scope of the invention as defined in the following claims.

What is claimed is:

1. An end plate for an electrochemical cell stack, the end plate comprising
an inner face, two end faces, a top face and a bottom face; and
at least one cavity for reducing the weight of the end plate, the at least one cavity being on at least one of the inner face, the two end faces, the top face and the bottom face, wherein the at least one cavity comprises at least fifteen percent of the volume of the end plate.

2. The end plate of claim 1, wherein the at least one cavity comprises at least ten holes.

3. The end plate of claim 1, wherein the inner face includes some or all of the at least one cavity.

4. The end plate of claim 3, wherein the inner face includes a central region and a peripheral region surrounding the central region, the at least one cavity being provided in the central region.

5. The end plate of claim 3, wherein the at least one cavity includes a plurality of blind holes, which plurality form an array of m rows and n columns of blind holes, where m and n are integers greater than one.

6. The end plate of claim 5, where m is greater than five and n is greater than ten.

7. The end plate of claim 3, wherein the inner face includes a central region and a peripheral region surrounding the central region, and the at least one cavity includes a plurality of blind holes, a first portion of the plurality of blind holes being provided in the peripheral region.

8. The end plate of claim 7, wherein a second portion of the plurality of blind holes are provided in the central region.

9. The end plate of claim 8, wherein the shape of the blind holes of the first portion are disparate from the shape of the blind holes of the second portion.

10. The end plate of claim 1, wherein each of the at least cavity is a blind hole with a depth of at least 40% of the thickness of the end plate.

11. The end plate of claim 10, wherein each of the at least one blind hole has a depth of at least 60% of the thickness of the end plate.

12. The end plate of claim 1, wherein each of the at least one cavity is a blind hole having substantially the same depth.

13. The end plate of claim 1, wherein each of the at least one cavity is round.

14. The end plate of claim 1, wherein each of the at least one cavity has a width of at least one-sixth the size of the lateral length of the end plate.

15. An end plate for an electrochemical stack, the end plate comprising
an inner face, two end faces, a top face and a bottom face, and
at least one cavity for reducing the weight of the end plate, the at least one cavity being on at least one of the inner face, the two end faces, the top face and the bottom face, wherein the at least one cavity is air-filled but otherwise empty when the electrochemical stack is in operation.

16. The end plate of claim 15, wherein the at least one cavity includes a through hole.

17. The end plate of claim 16, wherein the inner face has a central region and a peripheral region surrounding the central region, the through hole being provided in the central region.

18. The end plate of claim 15, wherein the at least one cavity includes a plurality of through holes, which plurality form an array of m rows and n columns of through holes, m and n being integers greater than one.

19. The end plate of claim 18, where m is greater than five and n is greater than ten.

20. The end plate of claim 15, wherein the end plate includes an inner face having a central region and a peripheral region surrounding the central region, and the at least one cavity includes a plurality of through holes, a first portion of the plurality of through holes being provided in the peripheral region.

21. The end plate of claim 20, wherein a second portion of the plurality of through holes are provided in the central region.

22. The end plate of claim 15, wherein the at least one cavity is a cylindrical through hole.

23. An end assembly for an electrochemical cell stack, the end assembly comprising at least two of
an end plate for attaching at least one connection port thereto for transmitting a fluid;
a terminal plate for connecting electrical leads thereto to draw current; and
an insulator plate for insulating, wherein the at least two are secured together with a securing agent.

24. The end assembly of claim 23, wherein the end assembly includes the terminal plate, the insulator plate and the end plate, and wherein the end plate has an inner face with at least one hole, the insulator plate has a corresponding at least one through hole, and the terminal plate has an outer face with a corresponding at least one hole, said holes used to secure together the terminal plate, the insulator plate and the end plate.

25. The system of claim 24, wherein the securing agent includes at least one bolt passing through the at least one through hole and engaging the at least one hole of the end plate and the terminal plate.

26. The system of claim 25, wherein the at least one hole in the end plate is a threaded blind hole, the at least one bolt engaging therewith.

27. The system of claim 25, wherein the at least one hole in the terminal plate is a threaded blind hole, the at least one bolt engaging therewith.

28. The system of claim 25, wherein the at least one hole in the end plate is a through hole, the at least one bolt passing therethrough and screwed on to at least one nut.

29. The system of claim 25, wherein the at least one hole in the terminal plate is a through hole, the at least one bolt passing therethrough and screwed on to at least one nut.

30. The system of claim 23, wherein the securing agent is one of a bolt, a screw, a snap, glue, heat solder and weld.

31. An end plate for an electrochemical cell stack, the end plate comprising
an inner face and an outer face each having a central region and a peripheral region;
a thickness measured along a stacking direction perpendicular to the central regions;
a left end face and a right end face; and
a height measured along a lateral direction that is perpendicular to the stacking direction and parallel to the left and right end faces,
wherein the end plate tapers to reduce weight such that at least one of the following two conditions holds,
i) the thickness of the end plate is smaller near the peripheral regions proximate to the end faces than near the central regions, and
ii) the height of the end plate is smaller near the peripheral regions proximate to the end faces than near the central regions.

32. The end plate of claim 31, wherein the inner face is planar and the outer face is non-planar.

33. An end plate for an electrochemical cell stack, the end plate comprising
an inner face;
an end face substantially perpendicular to the inner face;
an end face opening on the end face; and
an inner face opening on the inner face, the end face opening and the inner face opening being in fluid communication for the flow of a fluid.

34. An end plate for an electrochemical cell stack, the end plate comprising
an outer face;
an outer connection port on the outer face for allowing a fluid to pass therethrough;
an inner face;
an inner connection port on the inner face that corresponds to the outer connection port, wherein the outer connection port has a counter bore with an enlarged diameter and an inner bore with a reduced diameter for securing an external line for the fluid, the inner bore being in fluid communication with the inner connection port.

35. The end plate of claim 34, wherein a face of the counter bore includes at least one threaded hole for securing the external line for the fluid.
